(19) United States
(12) Patent Application Publication
(10) Pub. No.: US 2012/0223915 A1
(43) Pub. Date: Sep. 6, 2012

(54) TOUCH MODULE AND TOUCH DISPLAY USING THE SAME

(75) Inventors: Chien-Hung LIN, Taoyuan County (TW); Hsi-Fu LIN, Tao Yuan Shien (TW)

(73) Assignee: Quanta Computer Inc., Tao Yuan Shien (TW)

(21) Appl. No.: 13/164,225

(22) Filed: Jun. 20, 2011

(30) Foreign Application Priority Data
Mar. 3, 2011 (TW) 100107231

(51) Int. Cl. G06F 3/042

(52) U.S. Cl. 345/175

(57) ABSTRACT

A touch module disposed on a display panel of a touch display is provided. The touch module includes a glass substrate, a polymer layer, a lateral-side light sensor and a vertical-side light sensor. The polymer layer is transparent and flexible. The lateral-side and the vertical-side light sensors are sandwiched between the glass substrate and the polymer layer, and disposed on a lateral edge and a vertical edge of the substrate. A transparent transmission layer is formed between the glass substrate and the polymer layer. When a touch event is triggered on the polymer layer, the backlight corresponding to the touch point is transformed into a side-oriented backlight, which is transmitted in the transparent transmission layer and captured by the lateral-side and the vertical-side light sensor.

This application claims the benefit of Taiwan application Serial No. 100107231, filed Mar. 3, 2011, the subject matter of which is incorporated herein by reference.

### BACKGROUND OF THE INVENTION

1. Field of the Invention

The invention relates in general to a touch module and a touch display using the same, and more particularly to an optical touch module and a touch display using the same.

2. Description of the Related Art

With the rapid advance in technology nowadays, the touch display which provides an intuitive user interface, has been widely used in a diversity of electronic products. In general, the touch display can be divided into resistive type, capacitive type and optical type touch display. Let the optical type touch panel be taken for example. A light source and at least an image sensor are required for capturing the light reflected or generated by the light source, and reacting the captured light on the sensing image, so as to perform optical touch detection at the touch region (the surface of the display panel). When the user triggers a touch event at a touch region, the touch point blocks the passing of the light, so that dark point corresponding to the touch point position will be generated in the sensing image. Based on the position of the dark point in the sensing image, the angle between the line connecting the touch point and the image sensor and the corresponding edge of the touch panel can be obtained. Since the distance between the image sensors is already known, the coordinates of the touch point with respect to the display panel can thus be obtained.

In order to capture the sensing image of a touch region, the image sensor of a conventional optical type touch module must be protruded from the surface of the display panel, therefore the surface of the display panel cannot be implemented as full flat. Since an additional light source is required, power consumption and manufacturing cost will be increased.

### SUMMARY OF THE INVENTION

The invention is directed to a touch module and a touch display using the same. In comparison to the conventional touch display panel, the touch module and the touch display of the invention do not require additional light source, and incur low manufacturing cost and low power consumption.

According to a first aspect of the present invention, a touch display is provided. The touch display includes a display panel and a touch module. The display panel includes a backlight module, which provides a backlight. The touch module, disposed on the display panel, includes a glass substrate, a polymer layer, a lateral-side light sensor and a vertical-side light sensor. The polymer layer parallel to the glass substrate is transparent and flexible. The lateral-side and the vertical-side light sensors are sandwiched between the glass substrate and the polymer layer, and disposed on a lateral edge and a vertical edge of the substrate. A transparent transmission layer is formed between the glass substrate and the polymer layer. When a touch event is triggered on the polymer layer, the backlight corresponding to the touch point is transformed into a side-oriented backlight, which is transmitted in the transparent transmission layer and captured by the lateral-side and the vertical-side light sensor.

According to a second aspect of the present invention, a touch module used in a touch display is provided. The touch module is disposed on a display panel of the touch display. The display panel includes a backlight module, which provides a backlight. The touch module includes a glass substrate, a polymer layer, a lateral-side light sensor and a vertical-side light sensor. The polymer layer parallel to the glass substrate is transparent and flexible. The lateral-side and the vertical-side light sensors are sandwiched between the glass substrate and the polymer layer, and disposed on a lateral edge and a vertical edge of the substrate. A transparent transmission layer is formed between the glass substrate and the polymer layer. When a touch event is triggered on the polymer layer, the backlight corresponding to the touch point is transformed into a side-oriented backlight, which is transmitted in the transparent transmission layer and captured by the lateral-side and the vertical-side light sensor.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows an explosion diagram of a touch display according to an embodiment of the invention;

FIG. 2 shows a cross-sectional view along the cross-sectional line AA′ of FIG. 1;

FIG. 3 shows another cross-sectional view along the cross-sectional line AA′ of FIG. 1; and

FIG. 4 shows a distribution curve of a light intensity distribution signal Histogram_x.

### DETAILED DESCRIPTION OF THE INVENTION

The touch module of the embodiment of the invention uses the backlight module of a display for performing related optical touch detection.

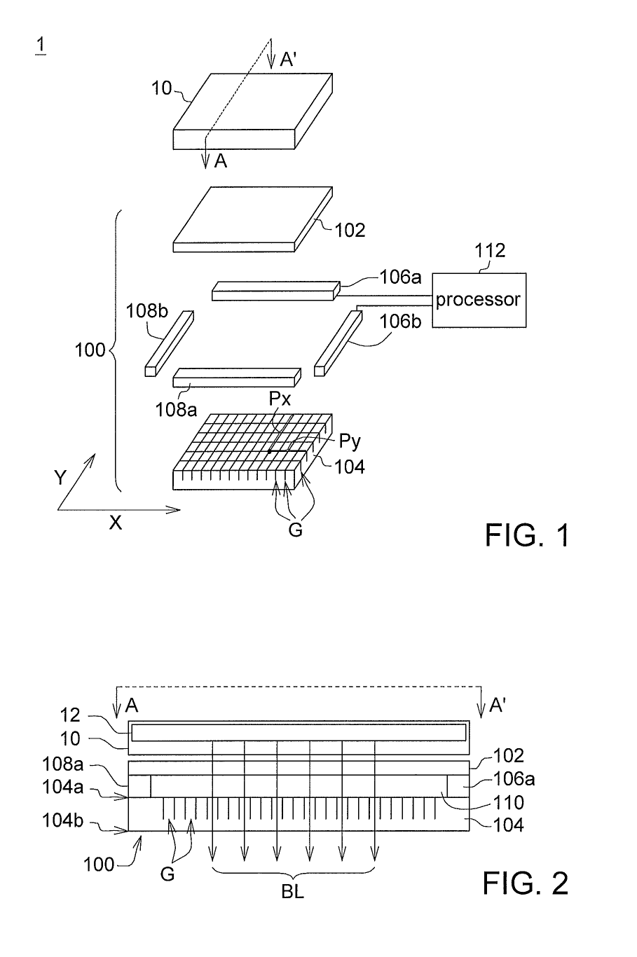

Referring to FIG. 1 and FIG. 2. FIG. 1 shows an explosion diagram of a touch display according to an embodiment of the invention. FIG. 2 shows a cross-sectional view along the cross-sectional line AA′ of FIG. 1. The touch display 1 includes a display panel 10 and a touch module 100. The display panel 10 includes a backlight module 12 which provides a backlight BL for displaying various information or patterns on the display panel 10.

The touch module 100, disposed on the display panel 10, includes a glass substrate 102, a polymer layer 104, a lateral-side light sensor 106a (the x-axis direction) and the vertical-side light sensor 106b (the y-axis direction).

The polymer layer 104, disposed in parallel to the glass substrate 102, is transparent and flexible. The polymer layer 104 includes a back surface 104a and a front surface 104b, wherein the front surface 104b is the surface on which the touch point P is located. The back surface 104a includes a plurality of grooves G whose extension direction is perpendicular to the front surface 104a. In a embodiment, the depth or length of the grooves G is about ½˜⅔ of the thickness of the polymer layer 104, and the interval between any two grooves G is such as 0.5 cm.

In a embodiment, the polymer layer 104 can be made from polyvinyl chloride (PVC), polyethylene terephthalate (PET), polyurethane (PU), polycarbonate (PC) or poly methyl methacrylate (PMMA).

The lateral-side spacer 108a and the vertical-side spacer 108b are selectively sandwiched between the glass substrate 102 and the polymer layer 104 for creating an space for receiving the lateral-side light sensor 106a and the vertical-side light sensor 106b, wherein the lateral-side light sensor 106a and the vertical-side light sensor 106b are respectively disposed on a lateral edge and a vertical edge of the glass substrate 102 and are perpendicular to each other.

In an embodiment, the lateral edge and the vertical edge respectively are a long side and a short side of the glass substrate 102. In an embodiment, the height of the lateral-side spacer 108a and the vertical-side spacer 108b is substantially identical to that of the lateral-side light sensor 106a and the vertical-side light sensor 106b. In an embodiment, the lateral-side spacer and the vertical-side spacer are sandwiched between the glass substrate and the polymer layer and disposed on another lateral edge and another vertical edge of the glass substrate.

A transparent transmission layer 110 is formed between the glass substrate 102 and the polymer layer 104. Furthermore, the transparent transmission layer 110 is a space surrounded by the glass substrate 102, the polymer layer 104, the lateral-side light sensor 106a, the lateral-side spacer 108a, the vertical-side light sensor 106b and the vertical-side spacer 108b, wherein the transparent transmission layer 110 contains a transparent medium with high transmittance (such as air) or a liquid with high refractive index, and, preferably, the liquid is a transparent liquid with high refractive index.

In a normal state (no touch event is triggered), as indicated in FIG. 2, the backlight BL, generated by a backlight module 12, sequentially passes through the glass substrate 102, the transparent transmission layer 110 and the polymer layer 104. Thus, the user can view the display screen of the touch display 1. Meanwhile, since almost no backlight BL is captured by the lateral-side light sensor 106a and the vertical-side light sensor 106b, the intensity of the light intensity distribution signal of the sensing image captured by the lateral-side light sensor 106a and the vertical-side light sensor 106b is very weak.

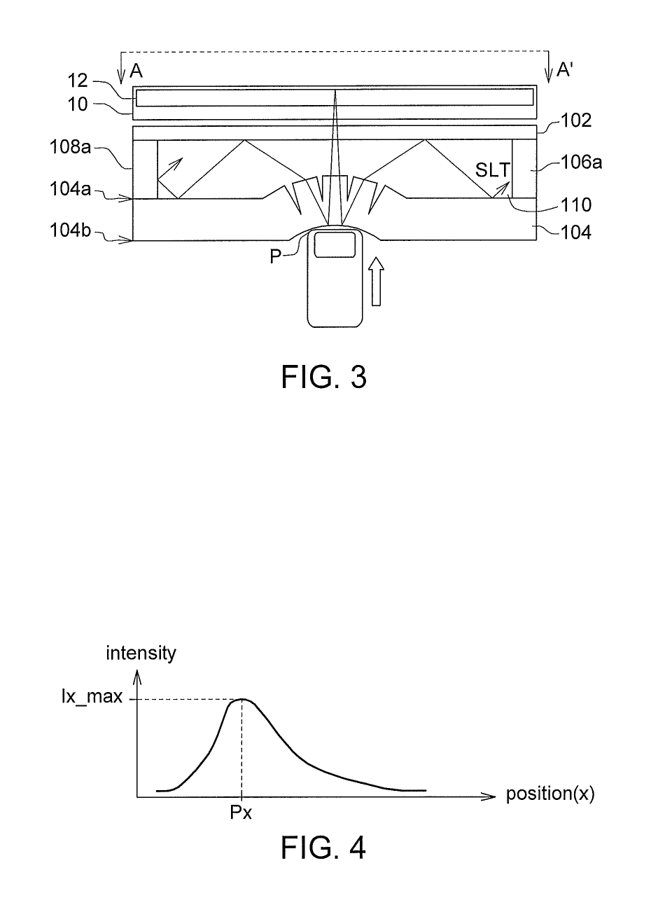

When the user triggers a touch event (for example, the user touches the front surface 104b with his/her finger to generate a touch point P), the polymer layer 104 being flexible, in response to the touch point P, will generate deformation on the front surface 104b and the back surface 104a, and cause the grooves G located on the back surface 104a to be deformed in a radial manner as indicated in FIG. 3. Thus, due to the deformation of the front surface 104b, the finger, the deformation of the grooves G and the function of the glass substrate 102, the backlight BL corresponding to the touch point P will be scattered, reflected and refracted, and a part of the scattered, reflected and refracted backlight BL (referred as “side-oriented backlight SLT” here below) is transmitted in the transparent transmission layer 110 and thus captured by the lateral-side light sensor 106a and the vertical-side light sensor 106b. Meanwhile, since the side-oriented backlight SLT is captured by the lateral-side light sensor 106a and the vertical-side light sensor 106b, a light point or region (due to the projection of the side-oriented backlight) would be generated on a particular position of the sensing image corresponding to the position of the touch point P. Afterwards, the position of the touch point P in the horizontal axis x and the vertical axis y (that is, the horizontal axis coordinate Px and the vertical axis coordinate Py) can be respectively obtained according to the position of the light point in the sensing image detected by the lateral-side light sensor 106a and the vertical-side light sensor 106. Then, positioning operation and touch function are thus completed.

Referring to FIG. 1 and FIG. 4. In response to a side-oriented backlight SLT, the lateral-side light sensor 106a generates a lateral-side light intensity distribution signal Histogram_x whose light point or peak value corresponds to the horizontal axis position (Px) of the touch point P. The processor 112 can determine the lateral-side position information corresponding to the touch point P through search for the peak value or the light point. Likewise, the vertical-side light sensor 106a, in response to a side-oriented backlight SLT, generates a lateral-side light intensity distribution signal Histogram_y whose light point or peak value also corresponds to the vertical axis position (Py) of the touch point P. The above process can be realized by the processor 112 of the touch module 100, which further obtains the coordinate (Px, Py) of the touch point P through calculation.

In the present embodiment of the invention, the structure of the polymer layer 104 is exemplified in FIGS. 1˜3. However, the polymer layer 104 of the present embodiment of the invention is not limited to the above exemplifications. In another example, the grooves G can be removed, and the backlight BL is reflected by the finger directly to correspondingly generate a side-oriented backlight SLT.

The touch module of the present embodiment of the invention is disposed on the display panel and includes a glass substrate and a polymer layer, wherein a lateral-side light sensor and a vertical-side light sensor are sandwiched between the glass substrate and a polymer layer. In a normal state, the backlight sequentially passes through the glass substrate, the transparent transmission layer and the polymer layer for enabling the touch display of the touch module of the present embodiment of the invention to perform ordinary display operation. When the user triggers a touch event on the polymer layer, the backlight corresponding to the touch point is reflected, scattered and refracted, and then a part of the side-oriented backlight SL is transformed into a side-oriented backlight SLT which is transmitted in the transparent transmission layer and finally captured by the lateral-side and the vertical-side light sensor. Thus, the lateral-side light sensor and the vertical-side light sensor can correspondingly perform positioning operation in response to the side-oriented backlight SLT.

In comparison to the conventional touch display panel, the touch module and the touch display using the same of the embodiment of the invention achieve full flat screen display function, use the light source generated by the backlight module for positioning, and have the advantages of low manufacturing cost and low power consumption.

While the invention has been described by way of example and in terms of the preferred embodiment (s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A touch display, comprising:
a display panel, comprising a backlight module, which provides a backlight; and
a touch module disposed on the display panel, wherein the touch module comprises:
a glass substrate;
a polymer layer parallel to the glass substrate, wherein the polymer layer is transparent and flexible; and
a lateral-side light sensor and a vertical-side light sensor sandwiched between the glass substrate and the polymer layer, wherein the lateral-side light sensor and the vertical-side light sensor are respectively disposed on a lateral edge and a vertical edge of the glass substrate, and a transparent transmission layer is formed between the glass substrate and the polymer layer.
wherein, when a touch event is triggered on the polymer layer, the backlight corresponding to the touch point is transformed into a side-oriented backlight, which is transmitted in the transparent transmission layer and captured by the lateral-side and the vertical-side light sensor.

2. The touch display according to claim 1, wherein the polymer layer comprises a plurality of grooves.

3. The touch display according to claim 1, wherein the lateral-side light sensor and the vertical-side light sensor respectively generate a lateral-side light intensity distribution signal and a vertical-side light intensity distribution signal in response to the side-oriented backlight;
wherein, the touch module further comprises:
a processor, which determines the lateral-side position information and the vertical-side position information of the touch point according to the lateral-side light intensity distribution signal and the vertical-side light intensity distribution signal respectively.

4. The touch display according to claim 1, further comprising:
a lateral-side spacer and a vertical-side spacer sandwiched between the glass substrate and the polymer layer and disposed on another lateral edge and another vertical edge of the glass substrate, wherein the height of the lateral-side spacer and the vertical-side spacer is substantially identical to that of the lateral-side light sensor and the vertical-side light sensor.

5. The touch display according to claim 1, wherein the polymer layer can be made from polyvinyl chloride (PVC), polyethylene terephthalate (PET), polyurethane (PU), polycarbonate (PC) or poly methyl methacrylate (PMMA).

6. A touch module used in a touch display, wherein the touch module is disposed on a display panel of the touch display, the display panel comprises a backlight module, which provides a backlight, and the touch module comprises:
a glass substrate;
a polymer layer parallel to the glass substrate, wherein the polymer layer is transparent and flexible; and
a lateral-side light sensor and a vertical-side light sensor sandwiched between the glass substrate and the polymer layer, wherein the lateral-side and the vertical-side light sensor are respectively disposed on a lateral edge and a vertical edge of the glass substrate, and a transparent transmission layer is formed between the glass substrate and the polymer layer;
wherein, when a touch event is triggered on the polymer layer, the backlight corresponding to the touch point is transformed into a side-oriented backlight, which is transmitted in the transparent transmission layer and captured by the lateral-side and the vertical-side light sensor.

7. The touch module according to claim 6, wherein the polymer layer comprises a plurality of grooves.

8. The touch module according to claim 6, wherein the lateral-side light sensor and the vertical-side light sensor respectively generate lateral-side light intensity distribution signal and a vertical-side light intensity distribution signal in response to the side-oriented backlight;
wherein, the touch module further comprising:
a processor, which demines the lateral-side position information and the vertical-side position information of the touch point according to the lateral-side light intensity distribution signal and the vertical-side light intensity distribution signal respectively.

9. The touch module according to claim 6, further comprising:
a lateral-side spacer and a vertical-side spacer sandwiched between the glass substrate and the polymer layer and disposed on another lateral edge and another vertical edge of the glass substrate, wherein the height of the lateral-side spacer and the vertical-side spacer is substantially identical to that of the lateral-side light sensor and the vertical-side light sensor.

10. The touch module according to claim 6, wherein the polymer layer can be made from polyvinyl chloride (PVC), polyethylene terephthalate (PET), polyurethane (PU), polycarbonate (PC) or poly methyl methacrylate (PMMA).
